(19) United States
(12) Patent Application Publication
(10) Pub. No.: US 2026/0307194 A1
(43) Pub. Date: Oct. 8, 2026

(54) MONITORING AND CONTROL OF MACHINING PROCESSES USING SUPERCRITICAL MACHINING FLUIDS

(71) Applicant: Fusion Coolant Systems, Inc., Canton, MI (US)

(72) Inventor: Steven J. Skerlos, Ann Arbor, MI (US)

(73) Assignee: Fusion Coolant Systems, Inc., Canton, MI (US)

(21) Appl. No.: 19/172,752

(22) Filed: Apr. 8, 2025

(51) Int. Cl. B23Q 11/10

(52) U.S. Cl. CPC B23Q 11/10

(57) ABSTRACT

The disclosure relates to supercritical machining fluid systems and methods for machining using supercritical machining fluid. A supercritical machining fluid source contains supercritical machining fluid and is in fluid communication with an outlet. One or more upstream sensors are configured to sense one or more parameters of the supercritical machining fluid upstream from the outlet and one or more downstream sensors are configured to sense one or more parameters of at least one flow of the supercritical machining fluid flowing out of the at least one outlet downstream from the at least one outlet. A state of the supercritical machining fluid upstream of the outlet may be determined and whether supercritical machining fluid flows from the outlet may be determined. One or more machining processes may be controlled based at least in part on the determined state of the supercritical machining fluid and flow of the supercritical machining fluid.

### FIELD

Disclosed embodiments are related to monitoring and control of machining processes using supercritical machining fluids.

### BACKGROUND

Machining tools, such as milling systems, lathes, computer numerical control (CNC) systems, robotic drills, and/or machining centers may employ machining fluids such as metalworking fluids to provide cooling and/or lubrication during a cutting or forming process. The machining fluid may be delivered to an interface between a cutting tool and a workpiece during a cutting or forming process. Conventional machining fluids may comprise mixtures including a cooling fluid (such as air, water, liquid carbon dioxide, or liquid nitrogen) to cool a cutting zone and a lubricant (such as oil, a minimum quantity lubrication (MQL) fluid, or synthetic fluids) to lubricate the cutting zone during a cutting process.

### SUMMARY

In some embodiments, a supercritical machining fluid system comprises a supercritical machining fluid source configured to contain a supercritical machining fluid and at least one outlet in fluid communication with the supercritical machining fluid source. The supercritical machining fluid system further comprises at least one upstream sensor configured to sense one or more parameters of the supercritical machining fluid upstream from the outlet and at least one downstream sensor configured to sense one or more parameters of at least one fluid flow from the supercritical machining fluid source flowing out of the at least one outlet downstream from the at least one outlet.

In some embodiments, a machining system comprises a supercritical machining fluid system comprising, where the supercritical machining fluid system comprises a supercritical machining fluid source configured to contain a supercritical machining fluid and at least one outlet in fluid communication with the supercritical machining fluid source. The supercritical machining fluid system further comprises at least one upstream sensor configured to sense one or more upstream parameters of the supercritical machining fluid upstream from the outlet and at least one downstream sensor configured to sense one or more parameters of at least one fluid flow from the supercritical machining fluid source flowing out of the at least one outlet downstream from the at least one outlet.

In some embodiments, a method for machining using supercritical machining fluid comprises sensing one or more upstream parameters of a supercritical machining fluid sourced from a supercritical machining fluid source upstream of at least one outlet and sensing one or more downstream parameters of a fluid flow from the supercritical machining fluid source downstream from the at least one outlet. The method further comprises controlling one or more machining processes based at least in part on the sensed one or more upstream parameters and the one or more downstream parameters.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a schematic representation of a machining system utilizing a supercritical machining fluid according to some embodiments;

FIG. 2 is a schematic representation of a centralized supercritical machining fluid distribution system according to some embodiments;

FIG. 3 is a schematic representation of a valve assembly according to some embodiments;

FIG. 4 is a schematic representation of a machining tool including upstream and downstream sensors according to some embodiments; and

FIG. 5 is a schematic flow diagram of a method for machining using supercritical machining fluid according to some embodiments.

### DETAILED DESCRIPTION

Many existing machining processes use machining fluids to cool and lubricate machine tools and workpieces to reduce wear and damage to the machine tool and/or a workpiece being machined. Cooling and lubrication may also help to reduce defects in the workpiece by reducing friction and heat generation while machining the workpiece. Some existing machining systems utilize supercritical fluids for such cooling and lubrication for improved cooling, lubrication, and/or more efficient heat transfer. Supercritical machining fluids may also provide for better mixing with lubricants or dissolution of lubricants, and/or allow for the use of smaller amounts of lubricants compared to conventional water-based machining fluids. Moreover, in some instances, rapidly expanding supercritical machining fluids comprising dissolved lubricants may precipitate small lubricant droplets travelling at high speed, which may provide superior lubrication relative to conventional machining fluids.

While the use of supercritical machining fluids may offer multiple different advantages, the Inventors have also recognized that the use of supercritical machining fluids have several shortcomings. For example, no adequate solution exists for monitoring or controlling a machining system based on a determination of whether a flow of supercritical machining fluid is being delivered to a cutting interface with a workpiece prior to beginning the machining process. This may result in inadequate cooling and lubrication of the machine tool and workpiece. Existing machining systems fail to detect if supercritical machining fluid is flowing out of an associated outlet in a supercritical state prior to beginning a machining process. If the supercritical machining fluid is not flowing and/or is flowing out of an outlet in a non-supercritical state this may result in high friction and machining at relatively high temperatures until the supercritical machining fluid begins flowing. These disadvantages may be especially detrimental when performing machining processes on temperature-sensitive materials (such as Inconel, or others) and/or performing high-output machining processes which generate high amounts of heat.

In view of the above, the Inventors have recognized that it is desirable to determine that a supercritical machining fluid is being delivered to a machining interface prior to initiating machining of a workpiece. However, determining that a supercritical machining fluid is flowing through an associated outlet of a machining system in a supercritical state is a non-trivial problem. Thus, the Inventors have further recognized that determining that the flow of the supercritical machining fluid being delivered to a cutting interface is flowing out of the outlet in a supercritical state may advantageously be based on one or more parameters of the supercritical machining fluid upstream of the outlet and one or more parameters of the supercritical machining fluid downstream of the outlet. The upstream and downstream parameters may be sensed by one or more upstream sensors and one or more downstream sensors, respectively, which may be configured to transmit signals to one or more processors which may be configured to determine if the supercritical machining fluid is in a supercritical state and is flowing out from one or more outlets towards a machining interface based at least in part on the sensed one or more upstream parameters and one or more downstream parameters. Based on this determination, the one or more processors may be configured to control one or more machining processes of the machining system. For example, a machining process of the machining system may be selectively permitted or prevented based at least in part on this determination as elaborated on further below.

While in some embodiments, a supercritical machining fluid may flow out of an outlet and/or be delivered to a machining interface in a supercritical state, the inventors have recognized that supercritical machining fluid may at least partially or entirely transition from a supercritical state to a subcritical state while the supercritical machining fluid flows towards and/or through the outlet. This transition may occur due to one or both of a reduction in temperature and pressure. For example, the supercritical machining fluid flow may at least partially transition from a supercritical state to a subcritical state including mixtures of a gas, liquid, and/or solid. This process and the resulting mixture may be referred to as a rapidly expanding supercritical fluid and/or a rapidly expanding supercritical fluid state. In some embodiments, such as when supercritical carbon dioxide is used, this subcritical state, which may occur either prior to or after the outlet of a system, may include a mixture of sublimated gas and solid carbon dioxide. Thus, it should be understood that confirming the flow of supercritical machining fluid in the current disclosure is not limited to confirming that the supercritical machining fluid is flowing through the outlet and/or to a machining interface in a supercritical state and instead is intended to confirm the flow of supercritical machining fluid is sufficient in flow rate and in the expected form to perform the desired machining process.

It will be appreciated that significant benefits are recognized from the novel systems and methods for controlling machining processes based on supercritical machining fluid flow as discussed herein. At a high-level, determining that a sufficient flow of supercritical machining fluid exists prior to beginning machining improves cooling and lubrication of the machining systems and workpieces to provide superior quality of machined workpieces, improved efficiency of machining processes, and increased lifespan of the machine tool. These benefits may be recognized as a result of earlier and increased cooling and/or lubrication, and in some cases more consistent cooling and/or lubrication of the machining system and workpiece. The inventors have recognized such benefits in systems using supercritical fluid as a machining fluid, where the parameters of the supercritical machining fluid can be used to determine a state and associated cooling capacity of the supercritical fluid, as well as the presence of a flow of the supercritical fluid being delivered to a cutting interface.

The disclosed methods and system may provide improved monitoring and control of machining systems by monitoring upstream parameters and downstream parameters of a supercritical machining fluid. As will be appreciated, the control may be provided in real-time and based on feedback in a closed-loop system. Upstream supercritical machining fluid is supercritical machining fluid located in a flowpath upstream relative to an outlet through which the supercritical machining fluid flows such as supercritical machining fluid contained in a supercritical machining fluid source, supercritical machining fluid flowing from the supercritical machining fluid source towards the outlet, and supercritical machining fluid located at any upstream position relative to a flow path of the supercritical machining fluid fluidly coupled to the associated outlet. Downstream supercritical machining fluid is supercritical machining fluid which has flowed out of the outlet and includes supercritical machining fluid output towards a machine tool, workpiece, and/or cutting interface.

The systems and methods discussed herein can use any appropriate variation of feedback (e.g., closed-loop) control. Examples of feedback control that can be implemented include proportional integral derivative (PID) control, linear quadratic regulation (LQR), linear quadratic gaussian (LQG), robust control, model predictive control (MPC), H-infinity control, fuzzy logic control, sliding mode control, gain-scheduled control, adaptive control, combinations thereof, and any other appropriate type of control as the disclosure is not limited in this sense. Regardless of the type of control used, one or more machining processes may be controlled based on one or both of determining a state of supercritical machining fluid upstream of the outlet and determining a flow of supercritical machining fluid from the outlet. More broadly, one or more machining processes and/or portions of the machining system may be controlled based on one or both of the upstream parameters and the downstream parameters. In some embodiments, a machining process may be prevented in response to determining that supercritical machining fluid is not flowing through the outlet, thereby preventing inadequate cooling and/or lubricating during the machining process. In some cases, the machining process may be prevented in response to determining that the state of supercritical machining fluid upstream of the outlet is in a non-critical state. In some embodiments, the machining process may be enabled in response to determining that supercritical machining fluid is flowing through the outlet.

In some embodiments, the machining system may determine the presence of a flow of supercritical machining fluid through an associated outlet based on one or more sensed upstream parameters (e.g., a sensed upstream temperature and/or pressure of the supercritical machining fluid) and one or more sensed downstream parameters. For example, the machining system may include a temperature sensor configured to sense a temperature of the supercritical machining fluid upstream from the outlet and a pressure sensor configured to sense a pressure of the supercritical machining fluid upstream of the outlet and may further include one or more sensors configured to sense one or more parameters downstream of the outlet. One or more processors may be configured to obtain signals from the upstream temperature and pressure sensors to determine that the supercritical machining fluid upstream from the outlet is in a supercritical state. The one or more processors may also be configured to determine that the supercritical machining fluid is flowing out from the outlet based on one or more signals received from the one or more downstream sensors as elaborated on further below. The one or more processors may then output a machining system control signal based at least in part on the signals obtained from the upstream and downstream sensors which may be indicative of whether or not a supercritical machining fluid is being delivered to a desired location during a machining process (e.g., machining interface, machine tool, workpiece, etc.). For example, the one or more processors may be configured to output a machining system control signal which prevents operation of the machining system based on a determination that supercritical machining fluid is not in a supercritical state and/or is not flowing through the outlet.

Any appropriate combination of sensors may be used to sense the upstream and downstream parameters. For example, an upstream sensor may be configured to sense parameters of the supercritical machining fluid upstream from the outlet and a downstream sensor may be configured to sense parameters of the supercritical machining fluid downstream from the outlet. Parameters of the supercritical machining fluid can include one or more of temperature, pressure, flow rate, mass flow rate, sound, vibration, position, velocity, acceleration, density, turbulence, capacitance, dielectric constants, absorption, refractive index, any combination thereof, and any other appropriate parameter. Sensing the downstream parameters may enable the machining system to determine if supercritical machining fluid is flowing through the outlet, and the machining system may be controlled based on the determination of supercritical machining fluid flow.

In some embodiments, the one or more upstream parameters may include a pressure of the supercritical machining fluid. A pressure sensor may be configured to sense the pressure, which in some cases may be pressure of a supercritical machining fluid source, a pressure of a flow of supercritical machining fluid, or other pressure associated with the systems and methods described herein. In some embodiments, the pressure sensor may be configured to sense a pressure of the supercritical machining fluid upstream of the outlet, e.g., supercritical machining fluid contained in a supercritical machining fluid source and/or within a flow path connecting the supercritical machining fluid source and the outlet. The sensed pressure may be used to determine if supercritical machining fluid is in a critical state. For example, the sensed pressure may be compared to a pressure at which the supercritical machining fluid is in a supercritical state to determine if the supercritical machining fluid upstream of the outlet is in a supercritical state. In some embodiments, the pressure sensor may be a strain gauge, piezoelectric sensor, manometer, Pirani sensor, Bourdon tube, barometer, pressure transducer, gyroscope, sealed pressure sensor, any combination thereof, and any other appropriate pressure sensor as the disclosure is not limited in this sense.

In some embodiments, the one or more upstream parameters may include a temperature of the supercritical machining fluid. A temperature sensor may be configured to sense a temperature of a supercritical machining fluid source, flow of the supercritical machining fluid, or any other appropriate temperature associated with the supercritical machining fluid upstream of the outlet of the machining system. In one example, the temperature sensor may be configured to sense a temperature of supercritical machining fluid stored in a supercritical machining fluid source, e.g., a supercritical machining fluid storage container. In another example, the temperature sensor may be configured to sense a temperature of supercritical machining fluid flowing through a flowpath towards the outlet. In some embodiments, the temperature sensor may directly or indirectly sense the temperature and may be a thermocouple, infrared sensor, laser temperature sensor, thermistor, resistive temperature detector, temperature probe, any combination thereof, and any other appropriate temperature sensor as the disclosure is not limited in this sense.

In some cases, the sensed upstream temperature and/or sensed upstream pressure may be used to together to determine a state of the supercritical machining fluid. For example, a supercritical machining fluid may be determined to be in a supercritical state if the sensed temperature and pressure are greater than a critical temperature and critical pressure respectively, or the supercritical machining fluid may be determined to be in a subcritical state (e.g., a liquid or gas) if either of the sensed temperature or pressure are below the critical temperature and critical pressure respectively. In some cases, temperatures and/or pressures at multiple upstream locations of the machining system may be sensed, and determination of the state of the supercritical machining fluid may be determined at each of these locations.

Any appropriate sensed parameter or combination of sensed parameters may be used to determine a flow of supercritical machining fluid through an outlet. As discussed below, any appropriate downstream sensor may be used to sense the downstream parameters. As described herein, the supercritical machining fluid may transition between states during application of the supercritical machining fluid, e.g., as the supercritical machining fluid flows through the outlet. In some cases, the sensed downstream parameters are indicative of a phase change of the supercritical machining fluid to a subcritical state. Various parameters may be sensed which indicate such a transition, such as pressure and temperature changes resulting from the expansion, as discussed further below. In one example, supercritical machining fluid may transition from a supercritical state to a gaseous state as the supercritical fluid flows through the outlet. As such, determining a transition of the supercritical machining fluid may be used to determine the presence of a flow of the supercritical machining fluid through the outlet of the machining system. The downstream sensors discussed herein may have any appropriate positioning and configuration. For example, the downstream sensors may be positioned in free space (e.g., not structurally supported by any portion of the machining system), coupled to a portion of the machining system, or positioned in any other appropriate way as the disclosure is not limited in this sense. In some embodiments, the downstream sensors may be oriented towards the machining tool, cutting interface, and/or workpiece, depending on the type of sensor.

Supercritical machining fluid flowing through the outlet of the machining system may expand into a gaseous state when exposed to atmospheric pressure, causing vibrations, sound waves, and/or other detectable changes in movement, position, velocity, and/or acceleration. In some embodiments, the downstream parameters may include the sound waves and/or information associated with sound waves such as sound wave intensity and/or sound wave frequency. The sound waves may be processed before being used to determine if a flow of supercritical machining fluid is flowing out from an outlet, as discussed below. In some embodiments, the vibrations, sound waves, and related parameters can be sensed by an acoustic sensor. The acoustic sensor may be configured to sense the sound waves associated with the flow of supercritical machining fluid, a machining process, or any other appropriate sound or sound waves associated with the systems and methods described herein. In some cases, the acoustic sensor may be configured to sense sounds associated with the cutting interface, such as sound waves emanating from supercritical machining fluid impacting one or more surfaces of the cutting interface. In some embodiments, the acoustic sensor may be a microphone, a piezoelectric transducer, ultrasonic sensor, laser Doppler vibrometer, acoustic emission sensor, and any other appropriate acoustic sensor as the disclosure is not limited in this sense.

In some embodiments, a vibration sensor may be configured to sense the vibration or other detectable changes in movement, position, velocity, and/or acceleration resulting from the flow or spray of supercritical machining fluid, or any other appropriate vibration or other movement associated with the systems and methods described herein. In one example, the vibration sensor may be configured to sense a vibration of the outlet and/or an associated nozzle, and the sensed vibration may be used to determine if supercritical machining fluid is flowing through the outlet. In some embodiments, a position sensor, velocity sensor, and/or acceleration sensor may be configured to sense a position, velocity, and/or acceleration, respectively, of supercritical machining fluid flow through the system, such as through the outlet. In some embodiments, the vibration sensor may be a displacement sensor, velocity sensor, acceleration sensor, accelerometer, strain gauge, gyroscope, laser displacement sensor, an imaging system with appropriate motion tracking, any combination thereof, and any other appropriate vibration sensor as the disclosure is not limited in this sense.

In some cases, a sensed sound, vibration, movement, position, velocity and/or acceleration signal may be processed prior to being used to determine if a supercritical machining fluid is flowing out of an outlet, e.g., in a preprocessing step to isolate or otherwise process the sensed parameter(s) prior to being used to determine the presence of the supercritical machining fluid flowing out from an outlet in a supercritical state. This may beneficially be used to remove frequencies associated with other processes and/or noises present in an environment that are unrelated to the flow of supercritical machining fluid out of the outlet. For example, one or more transformations may be performed on the detected sound, vibration, movement, position, velocity and/or acceleration, such as using a Fourier transform, Laplace transform, wavelet transform, convolution transform, any combination thereof, and any other appropriate transformation as the disclosure is not limited in this sense. In some embodiments, the sensed sound waves may be filtered using a low-pass filter, high-pass filter, band-reject filter, band-pass filter, notch filter, any combination thereof, and any other appropriate as the disclosure is not limited in this sense. According to some embodiments, the sensed sound waves or other sensed vibrations may be processed such that signals above or below a threshold intensity and/or threshold frequency may be disregarded for the purposes of controlling a machining process. In some cases, the sensed sound waves or vibrations may be transformed, filtered, and/or processed using a threshold intensity or threshold frequency cutoffs, and/or processed in any other appropriate way to resolve frequency and remove or reduce sensed sound waves which are unwanted, e.g., sensed sound waves which interfere with a desired set of sensed sound waves. In some embodiments, the processed sound, vibration, movement, position, velocity and/or acceleration data, e.g., which may transmitted via a signal, may be compared to a threshold magnitude to determine a flow of supercritical machining fluid.

In some embodiments, the one or more downstream parameters may include a temperature of the supercritical machining fluid and/or an area surrounding the flow of supercritical machining fluid. A downstream temperature sensor may be configured to sense a temperature of a flow or spray of the supercritical machining fluid, workpiece, machine tool, spindle, outlet, cutting interface, machining process, or any other appropriate downstream temperature associated with the systems and methods described herein. In one example, the temperature sensor may be configured to sense a temperature of supercritical machining fluid flowing through the outlet of the machining system. In another example, the temperature sensor may be configured to sense temperatures associated with machining a workpiece, e.g., the temperature of the workpiece during cutting, drilling, or performing another machining process to the workpiece. In some embodiments, a temperature of the flow of supercritical machining fluid through the outlet may be sensed.

In some cases, the sensed downstream temperature may be compared to various thresholds to determine whether or not a flow of supercritical machining fluid is flowing out of an associated outlet. For example, a sensed downstream temperature less than or equal to a threshold temperature may be used to determine that a supercritical machining fluid is flowing out of the associated outlet. The threshold temperature(s) used to process the downstream sensed temperatures may be different than the threshold temperature(s) used to process the upstream sensed temperatures. For example, the upstream threshold temperature used for preprocessing may be greater than the downstream threshold temperature, e.g., due to a drop in temperature from supercritical machining fluid transitioning to a non-critical expanded gas in the surrounding environment. For example, if the sensed downstream temperature is below the threshold temperature, which may indicate that the downstream location or area of the sensed temperature is being cooled by the supercritical machining fluid, it may be determined that the supercritical machining fluid is flowing from the outlet. In another example, the sensed temperature may be above the threshold temperature, which may indicate that the location or area of the sensed temperature is not being cooled by the supercritical machining fluid, and thus, it may be determined that supercritical machining fluid is not flowing through the outlet. In some cases, temperatures at multiple locations of the downstream space may be sensed, and determination of flow of the supercritical machining fluid may be based at least in part on a plurality of sensed temperatures being above or below the threshold temperature in one or more of the multiple locations.

In some embodiments, the flow of supercritical machining fluid may be determined based at least in part on a temperature differential, e.g., a temperature differential between a portion of the machining system and a surrounding environment or workpiece being greater than a threshold temperature differential which may indicate a large amount of cooling being applied due to the flow and expansion of a supercritical machining fluid. In some embodiments, the temperature sensor for sensing the downstream temperature may be a thermocouple, infrared sensor, laser temperature sensor, thermistor, resistive temperature detector, temperature probe, any combination thereof, and any other appropriate temperature sensor as the disclosure is not limited in this sense.

In some embodiments, the downstream parameters may include a density of the supercritical machining fluid and/or a turbulence change in the supercritical machining fluid. An ultrasonic sensor may be configured to sense the density or turbulence change, which in some cases may be associated with a flow or spray of supercritical machining fluid, or any other appropriate density or turbulence associated with the systems and methods described herein. In one example, the ultrasonic sensor may be configured to sense a density of supercritical machining fluid flowing through the outlet of the machining system. In another example, the ultrasonic sensor may be configured to sense a turbulence change associated with supercritical machining fluid flowing through the outlet. In some cases, the ultrasonic sensor may be configured to sense interference, for example, by sensing constructive or destructive interference patterns produced by overlapping wavefronts. In some embodiments, the constructive or destructive interference patterns may be detected as changes in amplitude, phase, or frequency of a sensed signal and the changes may be correlated with fluctuations in fluid density or localized turbulence. In some embodiments, the ultrasonic sensor may be a reflective sensor, through-beam sensor, dual-element ultrasonic sensor, any combination thereof, and any other appropriate ultrasonic sensor as the disclosure is not limited in this sense.

In some embodiments, the one or more downstream parameters may include a flow rate and/or mass flow rate. A flow sensor may be configured to sense the flow rate and/or mass flow rate, which may be associated with a flow or spray of supercritical machining fluid associated with the systems and methods described herein. For example, the flow sensor may be coupled to the outlet and configured to sense a flow rate of supercritical machining fluid flowing through the outlet. In some embodiments, the flow sensor may be an ultrasonic flow sensor, magnetic flow sensor, Coriolis flow meter, vortex flow meter, turbine flow meter, thermal flow sensor, positive displacement flow meter, target type flow sensor, differential pressure flow sensor, any combination thereof, and any other appropriate flow sensor as the disclosure is not limited in this sense. In some embodiments, the flow of supercritical machining fluid may be determined based on comparing the sensed flow rate to a threshold flow rate, e.g., if the sensed flow rate is above the threshold flow rate, it may be determined that supercritical machining fluid is flowing through the outlet.

In some embodiments, the one or more downstream parameters may include an absorption of light in one or more frequency ranges in an area surrounding the expected flow path of a supercritical machining fluid flowing out of an outlet. For example, an absorption sensor may be configured to sense an absorption of light within one or more frequency ranges in a downstream space, which may include a flow or spray of supercritical machining fluid flowing through the outlet during operation. In some cases, a flow of supercritical machining fluid may be determined based on a sensed absorption being greater than a threshold absorption (e.g., a percentage or ratio of light absorbed versus transmitted or emitted). Appropriate sensors may include, but are not limited to, a chemical absorption sensor, turbidity sensor, photosensitive detectors, any combination thereof, and any other appropriate absorption sensor as the disclosure is not limited in this sense.

In some embodiments, the one or more downstream parameters may include a capacitance and/or dielectric constant (i.e., relative permittivity) along an expected flow path of the flow of supercritical machining fluid and/or in an environment in which the supercritical machining fluid expands. Changes in capacitance and/or sensed dielectric constant may indicate the presence of a supercritical machining fluid, for example supercritical machining fluid transitioning from a supercritical state to a gaseous state as the supercritical machining fluid flows through the outlet. In this regard, a flow of supercritical machining fluid may be determined from one or both of comparing an absolute sensed value to an absolute threshold value and comparing a change in the sensed value to a threshold change. For example, a flow of supercritical machining fluid from the outlet may be determined based at least in part on comparing an absolute sensed capacitance and/or absolute dielectric constant to an absolute threshold capacitance and/or an absolute threshold dielectric constant, respectively. Alternatively or additionally, the flow of supercritical machining fluid may be determined based at least in part by comparing a change in a sensed capacitance and/or dielectric constant to a threshold change, e.g., a change in sensed capacitance above a threshold change in capacitance may be used to determine that supercritical machining fluid is flowing from the outlet.

A capacitive sensor (e.g., capacitance sensor or dielectric sensor) may be configured to sense the capacitance and/or dielectric constant, which in some cases may be associated with a flow or spray of supercritical machining fluid or other flow associated with the systems and methods described herein. The capacitive sensor may be configured to sense a humidity, e.g., a humidity proximate to the outlet, machine tool, workpiece, cutting interface, and/or other portion of the machining system according to some embodiments. In some embodiments, the capacitive sensor may be configured to sense a capacitance or dielectric constant of the supercritical machining fluid upstream of the outlet, e.g., supercritical machining fluid flowing through the system towards the outlet. In some embodiments, the capacitance sensor may be a time-domain-reflectometry sensor, planar interdigitated electrode sensor, open-ended coaxial probe sensor, parallel-plate sensor, ring resonator-based sensor, any combination thereof, and any other appropriate capacitive sensor as the disclosure is not limited in this sense.

In some embodiments, the downstream parameters may include a refractive index within an environment the supercritical machining fluid is flowing through and/or expanding. As used herein, “refractive index” describes a ratio of the speed of light in a vacuum to the speed of light in the medium in which the refractive index is being sensed. A flow of supercritical machining fluid may increase the refractive index (e.g., increase the refraction) of a space through which the supercritical machining fluid flows. As such, an increase in a sensed refractive index (or a sensed refractive index above a threshold refractive index) may be used to determine that supercritical machining fluid is flowing from the outlet. In this regard, a flow of supercritical machining fluid may be determined from one or both of comparing an absolute sensed value to an absolute threshold value and comparing a change in the sensed value to a threshold change. For example, a flow of supercritical machining fluid from the outlet may be determined based at least in part on comparing an absolute sensed refractive index to an absolute threshold refractive index. Alternatively or additionally, the flow of supercritical machining fluid may be determined based at least in part by comparing a change in a sensed refractive index to a threshold change, e.g., a change in sensed refractive index above a threshold change in refractive index may be used to determine that supercritical machining fluid is flowing from the outlet.

A refractive index sensor may be configured to sense the refractive index, and may be configured to sense the refractive index of the outlet, downstream space, or other appropriate portion of the machining system. In some embodiments, the refractive index sensor may be a fiber-optic sensor, photosensitive detector, Mach-Zehnder interferometric sensor, surface plasmon resonance (SPR) sensor, optical waveguide sensor, thermal lensing sensor, any combination thereof, and any other appropriate refractive index sensor as the disclosure is not limited in this sense.

Any of the sensors described herein may be configured to minimally interfere with the machining system and machining processes, such as application of the supercritical machining fluid and machining of the workpiece. Thus, in some embodiments the sensors may be selected to remotely sense or otherwise non-invasively sense the desired parameters to reduce potential interference with the machining process as appropriate. However, direct sensing of parameters with sensors configured to contact the supercritical machining fluid through either direct or indirect exposure to the flow is contemplated. In some embodiments, the machine tool may be configured to traverse from a first side of the workpiece to or towards a second side, e.g., by moving through the workpiece during the one or more machining processes. In such embodiments, it may be preferable to sense the one or more downstream parameters remotely or otherwise without contacting the machine tool due to limited exposure of the machine tool to the external environment (e.g., within the downstream space), thereby making sensing of the one or more downstream parameter impractical or impossible, e.g., due to the machine tool being positioned at least partially within the workpiece. For example, a drill bit may be positioned at least partially within a workpiece during a drilling operation, and supercritical machining fluid may flow from an outlet disposed on a portion of the drill bit which is positioned within the workpiece or is otherwise at least partially obstructed by the workpiece. The one or more downstream parameters of the supercritical machining fluid flowing through the outlet on the drill may be sensed indirectly using appropriate sensors as discussed previously above. Other machining processes performed by any appropriate machine tool may also benefit from the remote sensing for the same or alternative reasons discussed here, including but not limited to a swiss-type lathe, mill, and any other appropriate machine tool or combination of machine tools.

In some embodiments, downstream parameters may be sensed from a downstream space located downstream of the outlet, where the supercritical machining fluid flows through the outlet and into the downstream space towards the cutting interface. The presence of a flow of supercritical machining fluid through the outlet may be determined based at least in part using the downstream parameters sensed from the downstream space according to some embodiments. In some embodiments, the downstream space is located between the outlet of the machining system and the workpiece. The cutting interface may be located within and/or on a boundary of the downstream space according to some embodiments. The downstream parameters may be sensed from the downstream space using one or more of the sensors described above or other appropriate sensor and, in some embodiments, the downstream parameters may be sensed from a plurality of locations with a plurality of sensors. For example, one or more downstream parameters may be sensed from a first location and a second location of the downstream space with first and second downstream sensors. The parameters sensed from the first location and the second location may be used to determine the presence of a flow of supercritical machining fluid flowing out of the outlet according to some embodiments. In one example, the one or more parameters sensed from the first location may be compared with the one or more parameters sensed from the second location to determine the presence of a flow of supercritical machining fluid. One such case may include determining from a temperature differential between the first and second locations, where the determined temperature differential is greater than a threshold temperature differential and therefore is indicative of a supercritical machining fluid flow from the outlet. In another example, one or both of the parameters sensed from the first location and the second location may be compared with one or more threshold parameters to determine the presence of a flow of supercritical machining fluid through the outlet. Of course, as noted above and elsewhere herein, embodiments in which the downstream sensors are not located downstream from the outlet due to indirectly measuring one or more parameters of the downstream flow of supercritical machining fluid are also contemplated.

In some cases, the supercritical machining fluid may flow from the outlet in a substantially predictable trajectory. For example, if the upstream parameters of the supercritical machining fluid (e.g., pressure, temperature, and/or other parameters) are maintained approximately constant, the flow of the supercritical machining fluid through the outlet may follow a substantially consistent trajectory into the downstream space. As such, in some cases, the area of the downstream space through which the supercritical machining fluid flows may be predictable. In some cases, the predicted trajectory may also consider a shape of the outlet and/or an associated nozzle through which the supercritical machining fluid flows. The predictability of flows of supercritical machining fluid may help to enable determination of the presence of the flow based on sensing parameters from multiple locations, e.g., locations through which the flow is predicted to be present. As such, the presence of a flow of the supercritical machining fluid through the outlet may be determined based on sensing parameters sensed by multiple downstream sensors associated with multiple locations along an expected flow path of the supercritical machining fluid between an outlet and other locations such as a machining interface, machine tool, and/or workpiece according to some embodiments. For example, a predictable pattern and/or shape of flow may be recognized using sensed parameters from multiple locations to determine the presence of a flow of supercritical machining fluid through the outlet. In some cases, the predictable pattern and/or shape of flow may be recognized based on an image of the supercritical machining fluid flow. In some embodiments, the predictable pattern or shape may be a full cone, hollow cone, spiral, mist or fog, and in some cases may include curved features and/or flat features.

In some embodiments, the downstream sensor is a camera configured to image a downstream space, and the controller may be configured to receive the image and/or a downstream parameter obtained from the image. In some embodiments, at least a portion of the flow or spray of the supercritical machining fluid through the outlet may be imaged in the downstream space. Depending on environmental parameters of the downstream space, such as temperature, humidity, and others, the appearance of the imaged supercritical machining fluid spray may change (e.g., increased humidity may darken the image of the supercritical machining fluid spray). As such, it may be beneficial to include one or more additional downstream sensors configured to sense and transmit the environmental parameters such that the environmental parameters are considered when determining the presence of a flow of supercritical machining fluid based on the combination of the image and sensed environmental parameters.

Aspects described herein relate to improvements in machining systems that utilize supercritical machining fluids comprising a supercritical fluid, such as supercritical carbon dioxide (scCO₂) or supercritical nitrogen. Supercritical machining fluids may provide numerous benefits compared to conventional machining fluids, such as water-based machining fluids, oil-based machining fluids (e.g., neat oils), minimum quantity lubrication (MQL) fluids, or synthetic machining fluids. As used herein, a supercritical fluid refers to a fluid that is maintained above its critical point (i.e., at a temperature above the critical temperature and at a pressure above the critical pressure). For example, the critical temperature and pressure for carbon dioxide are 31.1° C. and 72.8 atm, respectively, which are readily achievable in industrial applications. Above the critical point, distinct liquid and gas phases do not exist; instead, supercritical fluids exhibit characteristics of both liquids and gases. For example, supercritical fluids may exhibit the flow and expansion behaviors of gasses while also being able to dissolve materials like a liquid. In machining applications, rapidly expanding supercritical machining fluids may provide better cooling and/or more efficient heat transfer, may provide for better mixing with lubricants or dissolution of lubricants, and/or allow for the use of smaller amounts of lubricants compared to conventional water-based machining fluids. Moreover, as described in more detail below, in some instances, rapidly expanding supercritical machining fluids comprising dissolved lubricants may precipitate small lubricant droplets travelling at high speed, which may provide superior lubrication relative to conventional machining fluids. Of course, while supercritical carbon dioxide is mentioned above and elsewhere herein, other appropriate types of supercritical fluids may also be used as a supercritical machining fluid as the disclosure is not so limited.

It should be understood that a supercritical machining fluid may be delivered to a machining system in a supercritical state in any appropriate manner and using any appropriate source and method to provide the desired supercritical machining fluid in the supercritical state. For example, in some embodiments, systems are described herein that can deliver a fluid to a machining tool below its critical pressure and/or critical temperature, and subsequently raise the pressure and/or temperature of the fluid at the machining system to generate a supercritical machining fluid upstream from an associated outlet. In some applications, a fluid may be stored above its critical pressure (e.g., in a storage tank associated with a machining tool and/or in a centralized storage system that is configured to distribute the high pressure fluid to multiple machining tools), and the fluid may be heated to a temperature above its critical temperature at each machining system when the supercritical machining fluid is used for a cutting process. In other applications, a supercritical machining fluid may be stored in one or more storage tanks specifically designed to store the supercritical machining fluid and maintain the fluid above the critical point during storage before it is needed during a cutting operation. As described in more detail below, in some embodiments, a supercritical fluid may be prepared and stored in a supercritical state and may be distributed to multiple machining systems through a centralized delivery system.

Moreover, depending on the particular embodiment, the temperature of a supercritical machining fluid may be adjusted as desired for different types of supercritical fluids and/or as appropriate for thermal management of a particular cutting process. For example, for systems utilizing scCO₂, the temperature may be maintained above 100° C. In some instances, maintaining warmer temperatures may be advantageous, for example to provide small, high velocity particles without overcooling. For example, maintaining a temperature substantially higher than the critical temperature of the supercritical fluid may be advantageous in some cutting processes. That said, the various systems and methods disclosed herein may use any appropriate temperature for a supercritical machining fluid above a critical temperature of the supercritical machining fluid at a desired location upstream from an associated outlet.

Additionally, systems utilizing a supercritical machining fluid may use various components such as pumps, valves, seals, and/or other plumbing arrangements that are selected to be compatible with the supercritical machining fluid. For example, such components may be used in connection with systems to deliver a supercritical machining fluid to a machining tool (such as from a centralized distribution system, and/or from supercritical fluid systems associated with a particular machining tool). Moreover, many components within machining tools may not be compatible with supercritical fluids. For example, many seals used in conventional machining tools are formed from materials that are readily solubilized by supercritical machining fluids, which would lead to degradation and/or failure of the machining system. Accordingly, some aspects described herein relate to materials (e.g., for sealing arrangements) that are suitable for use with supercritical machining fluids, as described in more detail below.

While various embodiments described herein refer to supercritical machining fluids, it should be understood that the current disclosure is not limited to supercritical machining fluids that are maintained in their supercritical state throughout the entirety of a machining process. In particular, in some embodiments, the supercritical machining fluid may start in its supercritical state but may fall below the critical temperature and/or pressure during the machining process. The inventors have recognized and appreciated that many of the benefits described herein associated with the supercritical state may still be maintained if the supercritical machining fluid drops below the critical point after flowing out from an outlet towards a desired location. Additionally, in some applications, a second machining fluid, such as a lubricant, may be mixed into a supercritical machining fluid which may advantageously result in the second machining fluid dispersing into small droplets upon expansion of the supercritical machining fluid. In particular, the inventors have appreciated that while the supercritical machining fluid is in the supercritical state, lubricant may be fully dissolved in the supercritical machining fluid (i.e., the lubricant may be fully soluble in the supercritical fluid) such that such droplets may not exist while the supercritical machining fluid is in a supercritical state. Accordingly, in some embodiments, droplets of lubricant may be formed only upon the supercritical machining fluid transitioning out of the supercritical state.

In some embodiments, the second machining fluid may flow from a second machining fluid source to mix with the supercritical machining fluid and/or be applied to one or more of the workpiece, cutting interface, and machine tool. In some instances, control of the one or more machining processes may be based at least in part on the second machining fluid. For example, the one or more machining processes may be prevented in response to determining that the second machining fluid is not flowing or is not flowing sufficiently (e.g., the flow rate of the second machining fluid is less than a threshold flow rate and is insufficient to lubricate the workpiece and/or machine tool). In another example, the one or more machining processes may be initiated based at least in part to determining that the second machining fluid is flowing or is flowing at a rate greater than a threshold flow rate. In some embodiments, a second machining fluid sensor may be configured to sense one or more parameters of the second machining fluid. For example, the second machining fluid sensor may be any appropriate flow sensor as described herein configured to sense a flow of the second machining fluid, e.g., from the second machining fluid source or other appropriate location such as a valve, pipe, tube, or other flow connection. In some embodiments, one or more sensors may be configured to sense the second machining fluid in the downstream space. For example, droplets of the second machining fluid (e.g., droplets of lubricant) from the flow of the second machining fluid (which in some cases may be included with the flow of supercritical machining fluid) may become dispersed into a population of droplets with a predetermined average size during rapid expansion of the supercritical machining fluid the second lubricant is dispersed in. The size of the population of droplets may be detectable using one or more sensors which may be compared to one or more size thresholds to determine if the second lubricant is flowing, e.g., downstream sensors, in the downstream space. In some cases, the droplets of second machining fluid may be sensed using a photosensitive detector, laser sensor, infrared sensor, any other appropriate sensor capable of detecting an average size of the sprayed droplets of the second lubricant as the disclosure is not limited in this sense. Regardless of how the second machining fluid is sensed, the at least one processor may be configured to receive the second machining fluid sensor signal and may output a machining control signal based at least in part on the second machining fluid sensor signal.

In some instances, a supercritical machining fluid may undergo rapid expansion as it is delivered into an open environment, such as when the supercritical fluid is delivered out of the outlet. The outlet may be formed on or as part of a nozzle or orifice of a cutting tool or tool holder at a cutting interface, or any other appropriate position of the machining system. Alternatively, the outlet may be part of a separate lubrication system that is configured to direct the flow of supercritical machining fluid towards a desired location.

As discussed herein, systems may be provided for supplying a supercritical machining fluid to an associated machining tool. For instance, appropriate machining tools and systems that the disclosed systems and methods may be used with may include a computer numerical control machine, lathe, turret lathe, mill, drill, robotic drill, Swiss-type lathe, multi-axis mill-turn center, multi-spindle lathe, gear hobbing machine, horizontal boring mill, any combination thereof, and any other appropriate machining tools and systems as the disclosure is not limited in this sense.

Moreover, while some embodiments described herein include a second machining fluid (e.g., a lubricant such as one or more oils, a metalworking fluid emulsion concentrate, and/or an MQL fluid) mixed with a supercritical fluid to form a supercritical machining fluid, it should be understood that the current disclosure is not limited to supercritical machining fluids including a second machining fluid. For example, in some applications, the supercritical fluid alone may provide sufficient cooling and/or lubrication during a cutting process. In other applications, a coolant fluid (e.g., water) may be added to a supercritical machining fluid to add mass and/or additional heat transfer capability to the supercritical machining fluid. Accordingly, it should be understood that a supercritical machining fluid may refer to a supercritical fluid with, or without, additional components such as lubricants or coolants.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

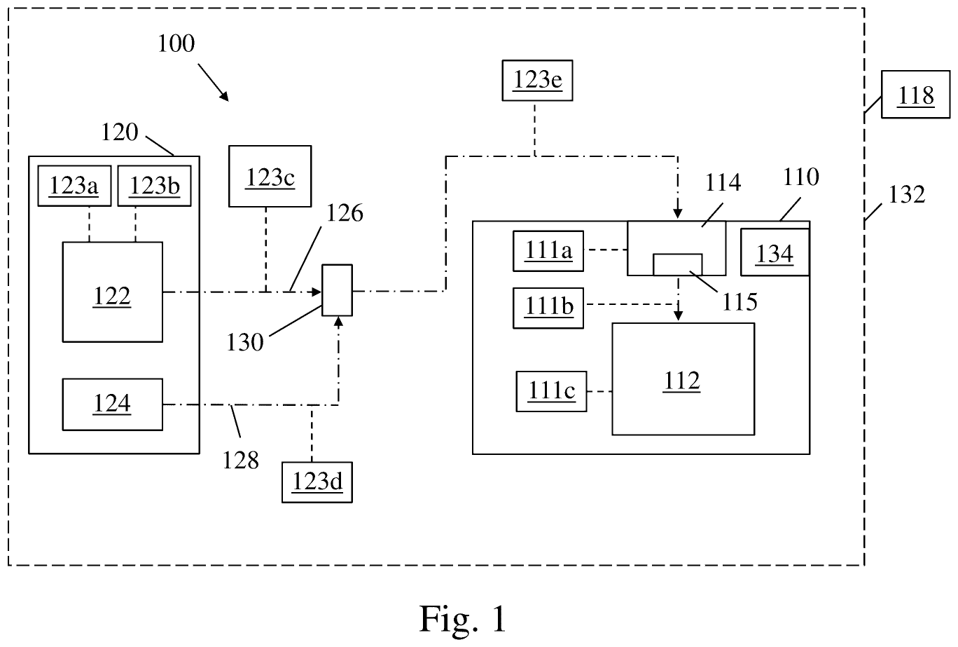

FIG. 1 is a schematic representation of a machining system 100 utilizing a supercritical machining fluid according to one exemplary embodiment. The system 100 includes a machining tool 110 (e.g., a CNC machine, a lathe, turret lathe, or other appropriate type of machining tool) including a cutting interface 112 where a cutting, forming or other machining process may be performed. For example, the cutting interface may include a rotating spindle to which a cutting tool may be attached. Some systems, such as turret lathe systems, may include multiple cutting tools that may be selected based on a particular desired cutting operation. The machining tool 110 further incudes a coupling 114, such as a rotary union, that couples the cutting interface to a machining fluid system 120. In some embodiments, such as in the depicted embodiment of FIG. 1, the coupling 114 includes an outlet 115 through which supercritical machining fluid flows from the machining fluid system 120 to the cutting interface 112. However, the outlet 115 need not be connected to the coupling 114 and rather can be positioned at any appropriate position on the machining system 110. Further, the outlet 115 may be separate from the machining system 110 in that the outlet 115 is configured to direct supercritical machining fluid to the cutting interface 112 without being coupled to any portion of the machining system 110. In some cases, the outlet 115 may be formed on a machine tool of the machining system, such as on the flutes of an endmill. Further, any appropriate number of outlets 115 configured to direct supercritical machining fluid to the cutting interface 112 may be formed on any appropriate portions of the system 100 and/or a separate lubrication system. For example, the a machine tool, a machine tool holder, a separate lubrication system, and/or any other appropriate structure may include a plurality of outlets 115 through which supercritical machining fluid flows.

The machining fluid system 120 includes a supercritical machining fluid source 122 configured to contain a supercritical machining fluid. In some embodiments, such as in the depicted embodiment of FIG. 1, the machining fluid system 120 may also include a lubricant source 124. In some embodiments, the supercritical machining fluid source may be configured to deliver a supercritical machining fluid (e.g., scCO₂) to the machining tool 110. However, embodiments in which conventional machining fluids (i.e., non-supercritical fluids) also may be used either separately from and/or in combination with the supercritical machining fluid are also contemplated. For example, a supercritical machining fluid and optional lubricant may be delivered to the coupling 114 and/or the outlet 115 via supply lines 126 and 128, respectively. Moreover, the machining tool 110 may include one or more controllers 118 having one or more processors configured to control various aspects of the operation of the machining tool, such as the operation of the cutting tool during a cutting operation. The controller 118 may also be operatively coupled to a valve arrangement 130 such that the one or more processors of the controller may control the delivery of supercritical fluid and/or lubricant to the machining tool 110.

Depending on the particular embodiment, the supercritical machining fluid source 120 may be a standalone system that may be coupled to an individual cutting tool to deliver the supercritical machining fluid to the cutting interface 112 during the cutting operation, or it may be a centralized distribution system configured to deliver supercritical machining fluid to multiple cutting tools within a machining or cutting center. Similarly, the lubricant source 124 may be a standalone system coupled to an individual machining tool, or the lubricant source may be a centralized lubricant distribution system configured to deliver lubricant to multiple machining tools within a machining facility.

As discussed herein, the machining system 100 may include various sensors for sensing upstream and downstream parameters. For example, the machining system 100 may include any appropriate number of upstream sensors 123a-123e configured to sense parameters of the supercritical machining fluid upstream of the outlet 115 as well as any appropriate number of downstream sensors 111a-111c configured to sense parameters downstream of the outlet 115. In some embodiments, the downstream sensors 111a-111c may be configured to sense parameters of the flow of supercritical machining fluid in a downstream space located downstream of the outlet 115. In some embodiments, the downstream space may be positioned between the outlet 115 and the cutting interface 112 according to some embodiments. In some cases, the downstream space includes the cutting interface 112. As discussed herein, the supercritical machining fluid may flow from the outlet 115 through the downstream space to the cutting interface 112. Accordingly, the one or more downstream sensors 111a-111c may be configured to sense parameters of the downstream space regardless of whether supercritical machining fluid is flowing through the outlet 115. However, embodiments in which the one or more downstream sensors 111a-111c indirectly measure one or more downstream parameters of the flow of supercritical fluid without being positioned in and/or oriented towards the downstream space are also contemplated as described previously above.

In the depicted embodiment of FIG. 1, the machining system 100 may include upstream sensors at any of the upstream locations indicated by upstream sensors 123a-123e configured to sense one or more parameters upstream from the outlet 115. This may include various locations and parameters as elaborated on below. Also shown in the depicted embodiment of FIG. 1, the machining system 100 may include one or more downstream sensors 111a-111c configured to sense one or more parameters of a flow of the supercritical machining fluid flowing out from the outlet 115. However, the sensors shown in the depicted embodiment of FIG. 1 merely represent possible arrangements of sensors in the machining system 100, and it should be understood that the machining system 100 may include any number, e.g., a subset, of the sensors 111a-111c and 123a-123e. Regardless of the quantity and configuration of the upstream sensors 123a-123e and downstream sensors 111a-111c, the upstream sensors 123a-123e and downstream sensors 111a-111c may include any appropriate combination of sensor types as the disclosure is not limited to any particular combination of sensor type.

In some embodiments, sensor 123a may be a temperature sensor configured to sense a temperature of the supercritical machining fluid source 122 and sensor 123b may be a pressure sensor configured to sense a pressure of the supercritical machining fluid source 122. However, it should be appreciated that sensors 123a and 123b may be any appropriate type of sensor described herein and are not limited to temperature sensors and pressure sensors.

In some embodiments, sensor 123c may be a flow sensor configured to sense a flow of fluid through the supply line 126. In some embodiments, sensor 123d may be a flow sensor configured to sense a flow of supercritical machining fluid through the supply line 128. In some embodiments, such as in the depicted embodiment of FIG. 1, the sensors 123c and 123d are positioned upstream of the valve arrangement 130. However, it should be appreciated that sensors 123c and 123d may be any appropriate type of sensor described herein and are not limited to flow sensors. In some embodiments, the sensor 123e may be a flow sensor configured to sense a flow of supercritical machining fluid flowing through the valve arrangement 130 flowing towards the outlet 115. However, it should be appreciated that sensor 123e may be any appropriate type of sensor described herein and is not limited to a flow sensor. Thus, it should be understood that the various described upstream sensors may be any appropriate sensor configured to output a signal related to one or more parameters that may be used as an indication that supercritical machining fluid is present and/or has been placed in fluid communication with an outlet 115 of the system.

As discussed herein, the system 100 may include one or more downstream sensors configured to sense parameters associated with the downstream space, which can include the flow of supercritical machining fluid through the outlet 115. The one or more downstream sensors may be configured to directly or indirectly sense one or more parameters associated with the flow of supercritical machining fluid through any appropriate portion of downstream space, the system 100 and/or machining tool 110 as the disclosure is not limited in this sense. For example, the depicted embodiment of FIG. 1 shows possible configurations of downstream sensors 111a-111c. In some embodiments, sensor 111a may be configured to sense parameters associated with the coupling 114 and/or outlet 115 and may optionally be coupled to the coupling 114, outlet 115, and/or an associated nozzle (not shown). In one example, the sensor 111a is a thermocouple coupled to the outlet 115 configured to sense a temperature of the outlet 115. In another example, the sensor 111a is a vibration sensor configured to sense vibrations of the outlet 115. In some embodiments, sensor 111b may be configured to sense parameters associated with the downstream space, such as supercritical machining fluid flowing through the downstream space. The sensor 111b may optionally be configured to sense the parameters remotely, i.e., without physically contacting a surface or area which the parameters are being sensed from. In one example, the sensor 111b is an infrared sensor configured to sense infrared wavelengths of light in the downstream space. In some embodiments, sensor 111c may be configured to sense parameters associated with the cutting interface 112 and/or the workpiece associated with the cutting interface. Optionally, the sensor 111c is coupled to the workpiece, a portion of the machine tool, and/or the cutting interface 112. Thus, the downstream sensors 111a-111c may correspond to any of the above disclosed types of downstream sensors and associated methods for determining an appropriate flow of supercritical machining fluid being delivered from an associated outlet or outlets of a system.

The system 100 may include any appropriate number of controllers having one or more processors configured to receive signals from the one or more upstream and one or more downstream sensors of the system 100 and control one or more portions of the system 100. The one or more processors may be configured to receive the signals from the sensor and control the one or more portions of the system 100, e.g., by outputting one or more machining system control signals. For example, in the depicted embodiment of FIG. 1, the one or more processors of controller 118 may be configured to communicate with and/or control each device within a control area 132. For example, the one or more processors of the controller 118 may be configured to receive signals from one or more of the sensors shown inside a control area 132. As such, each of one or more upstream sensors 123a-123e and one or more downstream sensors 111a-111c may be operatively coupled to the one or more processors of the controller 118 and the one or more processors of the controller 118 may be configured to receive signals from one or more of the one or more upstream sensors 123a-123e and the one or more downstream sensors 111a-111c. The one or more processors of the controller 118 may be configured to control one or more machining processes of the system 100 based at least in part on the received signals including selectively preventing one or more machining processes and/or initiating the one or more machining processes. For example, the one or more processors of the controller 118 may be configured to receive one or more signals from one or more of the one or more upstream sensors 123a-123e and one or more downstream sensors 111a-111c and determine the presence of a flow of supercritical machining fluid flowing through the outlet based at least in part on the received signals. The processor may be configured to output one or more machining system control signals based at least in part on the determined presence of supercritical machining fluid flowing out of the outlet 115. For example, if the supercritical machining fluid is not in a supercritical state and/or is not flowing out of the outlet, the one or more processors may be configured to prevent the machining system 110 from initiating one or more machining processes based on the output machining control signals. Alternatively, if the supercritical machining fluid is determined to be in a supercritical state and flowing out of the outlet 115 within a desired operation range the machining control signals may permit initiation of the one or more machining processes. In some embodiments, the machining system 110 includes one or more machining system controllers 134 with at least one machining system processor configured to receive the one or more output machining system control signals from the one or more processors of the controller 118, and the machining system processor may be configured to control operation of the machining system 110 based on the received one or more machining system control signals.

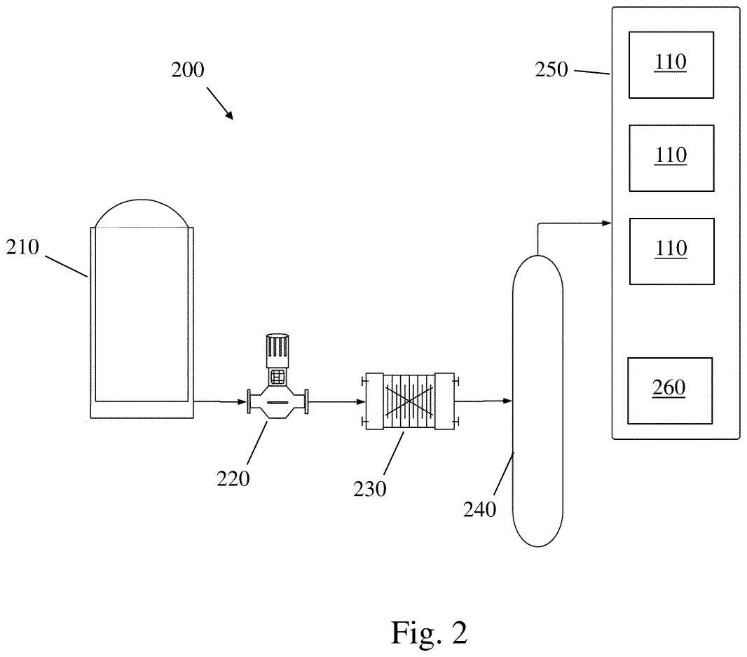

Referring now to FIG. 2, one embodiment of a system 200 for preparing and distributing a scCO₂-based supercritical machining fluid is described in more detail. The system of the depicted embodiment shown in FIG. 2 includes a storage tank 210 configured to contain liquid CO₂. For example, the storage tank 210 may be a vacuum jacketed, vertical tank in which the liquid CO₂ is maintained at a pressure of approximately 20 bar and a temperature of about 18° C. Liquid CO₂ is supplied from the storage tank 210 to one or more pumps 220 such as cryogenic pumps. In some embodiments, the liquid CO₂ may be drawn from the bottom of storage tank 210. In this manner, the system may utilize a head pressure of the liquid column in the storage tank to maintain a minimum net positive suction head (NPSH) at the suction port of the pump 220. The pump may be configured to compress the liquid CO₂ and increase the pressure of the liquid CO₂ to a pressure above the critical pressure, e.g., up to about 200 bar. The high-pressure liquid CO₂ is then directed through a heater 230, such as an electric vaporizer, that heats the CO₂ to a temperature above its critical temperature (i.e., greater than 31° C.). By heating the fluid to above its critical temperature, the high-pressure liquid CO₂ is converted to its supercritical state (scCO2). The scCO₂ is then transferred to a high pressure, large volume storage vessel 240, which may include one or more heating elements, insulation, and closed looped controls configured to maintain the temperature to ensure that scCO₂ remains above the critical temperature. When needed for machining operations, the scCO₂ is subsequently distributed from the storage vessel 240 and into a machining facility 250 including a plurality of machining tools 110, and the scCO₂ may be routed to the individual machining tools.

While a single storage tank 210 is shown in FIG. 2, it should be understood that other arrangements for providing a source of supercritical machining fluid may also be suitable. For example, as noted above, some embodiments may employ a plurality of smaller storage tanks (e.g., cylinders) coupled to one another to form a single larger storage volume. In some embodiments, such storage tanks may be located within the machining facility 250. Alternatively or additionally, some embodiments may employ multiple storage tanks and/or pluralities of smaller storage tanks arranged to form distribution cells that are configured to distribute the scCO₂ to different portions of a machining facility and/or to different subsets of machining tools within a machining facility.

Moreover, in some embodiments, the system 200 may further include a centralized lubricant distribution system 260. As discussed above, the lubricant distribution system may be constructed and arranged to distribute lubricant (e.g., MQL lubricant) to multiple machining tools 110, where the lubricant may be mixed with the scCO₂ machining fluid. Alternatively, each machining tool may be provided with a separate lubricant source that is coupled to a source of scCO₂ from the system 200.

In the depicted embodiment, the scCO₂ is prepared and stored outside of the machining facility 250 and distributed to machining tools 110 located within the machining facility 250. However, embodiments in which some or all of the components of the system 200 are located within the machining facility 250 are also contemplated. For example, in one embodiment, the storage tank 210 may be located outside of the machining facility, while the pump 220, heater 230, and storage vessel 240 may be located within the machining facility. Moreover, while three machining tools 110 are depicted in the figure, it should be understood that the centralized distribution systems described herein may be used with any suitable number of machining tools.

In some embodiments, the system 200 may include a single set of upstream sensors configured to sense parameters for determining a state of the supercritical machining fluid. For example, the system 200 may include one temperature sensor configured to sense a temperature of the storage vessel 240 and one pressure sensor configured to sense a pressure of the storage vessel 240. In some embodiments, each of the machining tools 110 may include a set of upstream sensors configured to determine a state of the upstream supercritical machining fluid. For example, each of the machining tools 110 may include one temperature sensor configured to sense a temperature of supercritical machining fluid delivered to the respective machining tool and one pressure sensor configured to sense a pressure of supercritical machining fluid delivered to the respective machining tool as discussed herein. Regardless of the configuration of upstream sensors, the each of the machining tools 110 may include at least one downstream sensor configured to sense one or more downstream parameters for determining whether machining fluid is flowing at each of the respective machining tools 110.

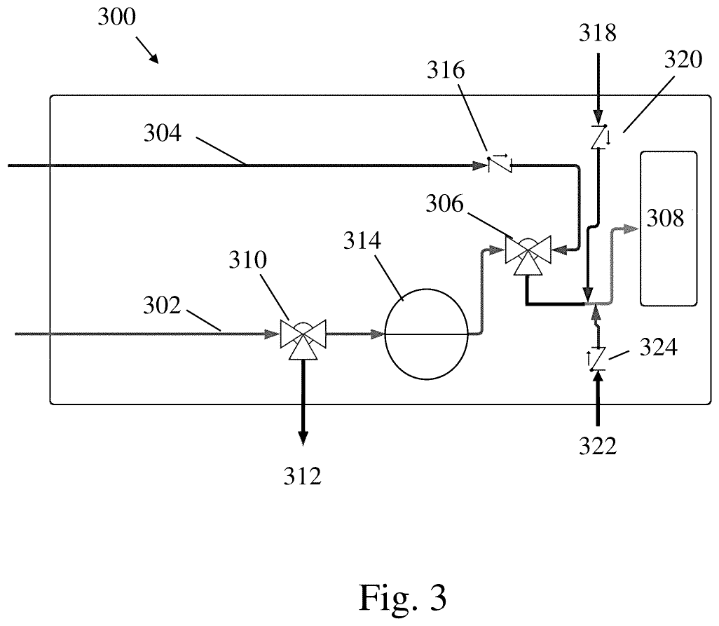

FIG. 3 depicts a schematic flow chart illustrating the operation of a valve arrangement 300, according to some embodiments. The valve arrangement 300 may provide for switching between a supercritical machining fluid, a conventional (non-supercritical) machining fluid, and a mixture of the supercritical machining fluid and the conventional machining fluid as may be desired for different matching operations. The system includes a supercritical fluid source 302 and a non-supercritical fluid source 304, which are each routed to a first three-way valve 306 configured to selectively permit flow of the desired machining fluid to a machining tool 308. Depending on the particular embodiment, the first three way valve may be a manual valve or an automated valve, such as a pneumatically controlled valve.

A second three-way valve 310 is positioned between the supercritical fluid source 302 and the first three way valve 306. The second three-way valve 312 may be configured to allow for routing the supercritical fluid to an exhaust 312, such as to purge pressure in the machining tool 308 during a tool change. In some embodiments, the second three-way valve may be a solenoid valve, though other types of valves may be suitable. A pressure sensor 314 is positioned between the first three-way valve 306 and second three-way valves 310 to monitor pressure behind the machining tool. In some applications, one or more operations of the machining tool may be controlled by one or more processors of a controller on the machining tool based on the measured pressure. For example, the machining tool may be configured to shut down a cutting operation and purge the pressure (via the second three-way valve) in the event that the pressure increases beyond a predetermined level. Moreover, flow of the non-supercritical fluid to the first three-way valve 306 may be controlled via a valve 316 (such as a check valve) associated with the non-supercritical fluid source 304.

In some embodiments, the valve arrangement may be further configured to supply a lubricant to a machining fluid from a lubricant source 318, and the flow of the lubricant may be controlled via a valve 320, such as a check valve, associated with the lubricant source. Similarly, the valve arrangement may include an additive source 322 configured to supply additives to the machining fluid, such as compressed air, and valve 324 may control delivery of the additive. In some instances, the lubricant source and compressed air source may be employed to provide a third machining fluid option (i.e., an air-dispersed lubricant such as an MQL lubricant).

While the embodiment described above is configured to selectively deliver a supercritical fluid and a non-supercritical fluid, it should be understood that other arrangements may be suitable. For instance, some embodiments may comprise supplies of two different supercritical fluids (e.g., scCO₂ pre-mixed with different lubricants), and the three way valve may be employed to selectively deliver one of the supercritical fluids. Moreover, while the valve arrangement is depicted as being outside of a machine tool, it should be understood that the current disclosure is not limited in this regard, and that some embodiments may include a valve arrangement positioned within a machine tool to permit selection of an appropriate machining fluid from a plurality of machining fluids delivered to the machining tool.

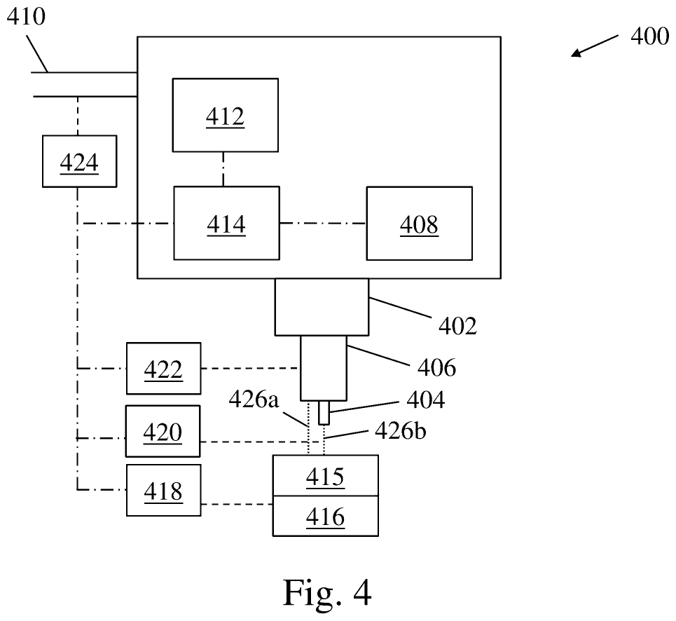

FIG. 4 is a schematic representation of one embodiment of a machining tool 400 including upstream and downstream sensors. The machining tool 400 may include a spindle 402 or other appropriate structure to which a cutting tool 404 may be attached via a toolholder 406. The machining tool 400 may include one or more drive motors 408 configured to drive rotation of the cutting tool 404 during a cutting operation. However, embodiments in which a workpiece 416 is driven relative to a stationary cutting tool 404 are also contemplated. In the depicted embodiment, a supercritical machining fluid may be supplied to the machining tool 400 via a supercritical fluid source 410. The supercritical fluid may be delivered to a cutting interface 415 in any suitable manner, such as through the machining tool 400 including through the spindle 402 and toolholder 406, e.g., through an outlet as a supercritical machining fluid flow 426a according to some embodiments. Additionally or alternatively, the supercritical machining fluid may be delivered to the cutting interface 415 through the cutting tool 404, e.g., through an outlet of the cutting tool 404 as a supercritical machining fluid flow 426b according to some embodiments. Alternatively, a separately routed outlet that is not integrated with the machining tool may also be used (e.g., nozzles positioned adjacent to and oriented towards the machine tool, cutting interface, and/or workpiece). In some embodiments, the machining tool 400 may be configured to receive supercritical machining fluid from a common distribution system configured to deliver supercritical machining fluid to multiple separate machining systems or may be configured to receive supercritical machining fluid from a single system dedicated to providing supercritical machining fluid for the system 400 as the disclosure is not limited in this sense.

As discussed herein, the machining tool 400 may include one or more upstream sensors and one or more downstream sensors. For example, as shown in the depicted embodiment of FIG. 4, the system may include one or more upstream sensors 414, 424 and/or one or more downstream sensors 418, 420, and 422 which may be operatively coupled to one or more processors of a controller 414. While the depicted embodiment of FIG. 4 shows a single controller 414, it should be appreciated that the machining tool 400 may include any appropriate number of controllers as the disclosure is not limited in this sense. The one or more processors of the controller 414 may be configured to receive signals from one or more of the sensors 414, 418, 420, 422, 424 and may be configured to determine whether or not a flow of the supercritical machining fluid 426a and/or 426b out of an associated outlet in the supercritical state is present according to some embodiments. The one or more processors of the controller 414 may be configured to output one or more machining control signals or otherwise be configured to selectively prevent or permit operation of the machining system based at least in part on this determination. For example, by stopping the drive motors 408, in response to determining supercritical machining fluid is not flowing. In some embodiments, stopping the drive motors 408 may include preventing the drive motors 408 from bringing the cutting tool 404 into contact with the workpiece 416, prevent rotation or other movement of the cutting tool 404, or otherwise preventing the cutting tool 404 from forming a cutting interface. The one or more processors of the controller 414 may be configured to stop the drive motors 408 by outputting a control signal according to some embodiments.

The downstream sensors 418, 420, and 422 may be any appropriate sensor described herein as the disclosure is not limited to any particular type of downstream sensor. For example, one or more of the downstream sensors may be a photosensitive detector, temperature sensor, infrared sensor, any other sensor described above, or any other appropriate sensor as the disclosure is not so limited. Regardless of the quantity or type of sensors included in the machining tool 400, the one or more processors of the controller 414 may be configured to receive signals from the upstream sensors which include information regarding upstream parameters and receive signals from the downstream sensors which include information regarding downstream parameters and may determine a state of the upstream supercritical machining fluids and/or a flow of supercritical machining fluid based on the received signals. The one or more processors may control the machining tool 400 based on one or both of the determined flow of supercritical machining fluid and state of upstream supercritical machining fluid, such as preventing operation of the machining tool 400 as discussed herein.

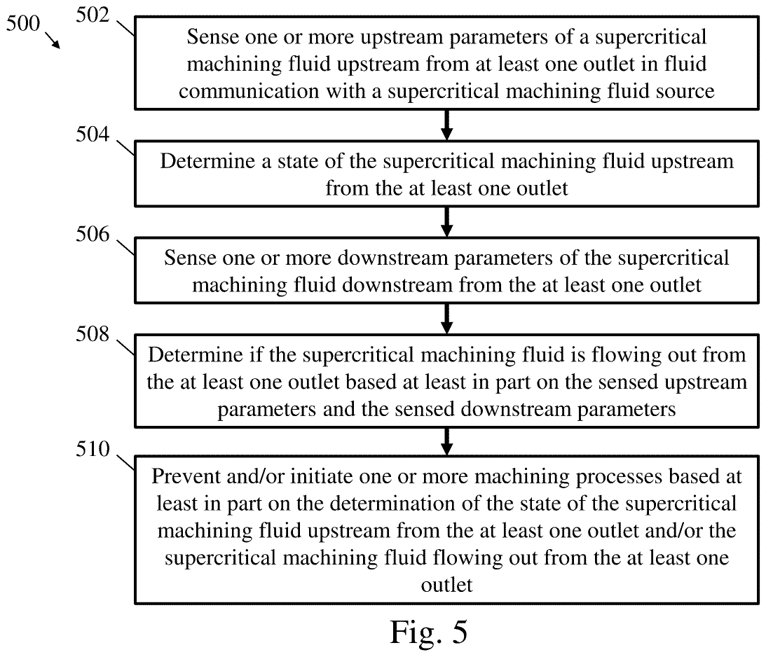

FIG. 5 shows a schematic flow diagram of a method 500 for machining using supercritical machining fluid according to some embodiments. At 502, one or more upstream parameters of a supercritical machining fluid upstream from at least one outlet in fluid communication with a supercritical machining fluid reservoir may be sensed. For example, one or more upstream sensors 123a-123e may sense one or more parameters of the supercritical machining fluid upstream of the outlet 115 as shown in the depicted embodiment of FIG. 1. At 504, a state of the supercritical machining fluid upstream of the at least one outlet may be determined. For example, the state of the supercritical machining fluid (e.g., supercritical or subcritical) may be determined by the one or more processors of the one or more controllers 118 based at least in part on signals received from the one or more of the upstream sensors 123a-123e. At 506, one or more downstream parameters of the supercritical machining fluid associated with a flow of supercritical machining fluid flowing out of the outlet may be sensed. For example, one or more of the downstream sensors 111a-111c may be configured to sense parameters of the supercritical machining fluid flowing from the outlet 115. At 508, it may be determined whether the supercritical machining fluid is flowing out from the at least one outlet based at least in part on the sensed downstream parameters. For example, the one or more processors of the one or more controllers 118 may be configured to determine if supercritical machining fluid is flowing from the outlet 115 based on the signals received from the one or more downstream sensors 111a-111c. At 510, one or more machining processes may be selectively prevented and/or initiated based at least in part on the determination of the state of the supercritical machining fluid upstream from the at least one outlet and/or whether or not the supercritical machining fluid is flowing out from the at least one outlet. In some embodiments, the one or more machining processes may be selectively controlled based at least in part on both of these determinations. For example, the one or more processors of the one or more controllers 118 may be configured to prevent and/or initiate operation of the machining system, e.g., in performing a cutting or other machining process, based on the determined state of the supercritical machining fluid upstream of the outlet 115 and/or determining a flow of the supercritical machining fluid through outlet 115.

In some embodiments, the one or more machining processes may be prevented based on the determination that the state of the supercritical machining fluid upstream of the outlet is in a non-critical state, such as liquid or gas. In some embodiments, the one or more machining processes may be initiated based on the determination that the state of the supercritical machining fluid upstream of the outlet is in a critical state. In some embodiments, the one or more machining processes may be prevented based on the determination that the state of the supercritical machining fluid upstream of the outlet is in a non-critical state and/or that the supercritical machining fluid is not flowing from the outlet. In some embodiments, the one or more machining processes may be initiated based on the determination that the state of the supercritical machining fluid upstream of the outlet is in critical state and that the supercritical machining fluid is flowing from the outlet.

As discussed herein, preventing one or more machining processes may include outputting a lockout signal, e.g., from the one or more processors of the one or more controllers 118. The one or more processors of the one or more controllers of the machining system 110 may receive lockout signal, and may not perform the one or more machining processes in response to receiving the lockout signal. In some cases, the function of preventing operation of the machining system, e.g., preventing one or more machining processes, may be referred to as lockout control or interlock control. The methods discussed herein involve closed-loop control involving feedback, e.g., sensed parameters, from at least one sensor and controlling the machining system based on the feedback. Any of the systems and methods discussed herein may include real-time feedback and control to improve the efficiency and precision of control.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computing device including one or more processors may be embodied in any of a number of forms, such as a rack-mounted computer, a desktop computer, a laptop computer, or a tablet computer. Additionally, a computing device may be embedded in a device not generally regarded as a computing device but with suitable processing capabilities, including a Personal Digital Assistant (PDA), a smart phone, tablet, or any other suitable portable or fixed electronic device.

Also, a computing device may have one or more input and output devices. These devices can be used, among other things, to present a user interface. Examples of output devices that can be used to provide a user interface include display screens for visual presentation of output and speakers or other sound generating devices for audible presentation of output. Examples of input devices that can be used for a user interface include keyboards, individual buttons, and pointing devices, such as mice, touch pads, and digitizing tablets. As another example, a computing device may receive input information through speech recognition or in other audible format.

Such computing devices may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, RAM, ROM, EEPROM, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computing devices or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computing device or other processor to implement various aspects of the present disclosure as discussed above. Additionally, it should be appreciated that according to one aspect of this embodiment, one or more computer programs that when executed perform methods of the present disclosure need not reside on a single computing device or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

1. A supercritical machining fluid system comprising:
a supercritical machining fluid source configured to contain a supercritical machining fluid;
at least one outlet in fluid communication with the supercritical machining fluid source;
at least one upstream sensor configured to sense one or more parameters of the supercritical machining fluid upstream from the at least outlet; and
at least one downstream sensor configured to sense one or more parameters of at least one fluid flow from the supercritical machining fluid source flowing out of the at least one outlet downstream from the at least one outlet.

2. The supercritical machining fluid system of claim 1, further comprising at least one processor configured to output a machining system control signal based at least in part on a downstream signal from the at least one downstream sensor and an upstream signal from the at least one upstream sensor.

3. The supercritical machining fluid system of claim 2, wherein the machining system control signal is a machining lockout signal.

4. The supercritical machining fluid system of claim 1, further comprising at least one processor configured to receive a downstream signal from the at least one downstream sensor, wherein the at least one processor is configured to determine if the at least one fluid flow is flowing out from the at least one outlet based at least in part on the received downstream signal.

5. The supercritical machining fluid system of claim 4, wherein the at least one processor is configured to receive an upstream signal from the at least one upstream sensor, wherein the at least one processor is configured to determine if the supercritical machining fluid is in a supercritical state based at least in part on the received upstream signal.

6. The supercritical machining fluid system of claim 1, further comprising a second machining fluid source configured to contain a second machining fluid, wherein the second machining fluid source is in fluid communication with the at least one outlet.

7. The supercritical machining fluid system of claim 6, further comprising a second machining fluid sensor and at least one processor, the second machining fluid sensor configured to sense one or more parameters of the second machining fluid, wherein the at least one processor is configured to output a machining system control signal based at least in part on: a downstream signal from the at least one downstream sensor, an upstream signal from the at least one upstream sensor, and a second machining fluid signal from the second machining fluid sensor.

8. The supercritical machining fluid system of claim 7, wherein the second machining fluid sensor is configured to sense a flow of the second machining fluid from the second machining fluid source.

9. The supercritical machining fluid system of claim 6, wherein the second machining fluid is a lubricant.

10. The supercritical machining fluid system of claim 9, wherein the lubricant comprises at least one selected from a group of: an oil, a minimum quantity lubrication fluid, and a pre-mixed lubricant formulation.

11. The supercritical machining fluid system of claim 1, wherein the supercritical machining fluid comprises supercritical carbon dioxide.

12. The supercritical machining fluid system of claim 1, wherein one or both of the at least one upstream sensor and the at least one downstream sensor include at least one photosensitive detector.

13. The supercritical machining fluid system of claim 1, wherein one or both of the at least one upstream sensor and the at least one downstream sensor include at least one temperature sensor.

14. The supercritical machining fluid system of claim 1, wherein one or both of the at least one upstream sensor and the at least one downstream sensor include at least one ultrasonic sensor.

15. The supercritical machining fluid system of claim 1, wherein one or both of the at least one upstream sensor and the at least one downstream sensor include at least one chemical absorption sensor.

16. The supercritical machining fluid system of claim 1, wherein one or both of the at least one upstream sensor and the at least one downstream sensor include at least one capacitance sensor.

17. The supercritical machining fluid system of claim 1, wherein one or both of the at least one upstream sensor and the at least one downstream sensor include at least one dielectric sensor.

18. The supercritical machining fluid system of claim 1, wherein one or both of the at least one upstream sensor and the at least one downstream sensor include at least one mass flow sensor.

19. The supercritical machining fluid system of claim 1, wherein one or both of the at least one upstream sensor and the at least one downstream sensor include at least one fiber-optic sensor.

20. The supercritical machining fluid system of claim 1, wherein the at least one outlet is configured to direct the at least one fluid flow flowing out of the at least one outlet towards a cutting interface formed between a workpiece and a machine tool.

21. The supercritical machining fluid system of claim 1, wherein the at least one fluid flow includes the supercritical machining fluid in or more of a supercritical, solid, and gaseous state.

22. The supercritical machining fluid system of claim 1, wherein the at least one fluid flow flowing out of the at least one outlet includes the supercritical machining fluid in a supercritical state.

23. The supercritical machining fluid system of claim 1, wherein the at least one fluid flow between the supercritical machining fluid source and the at least one outlet includes the supercritical machining fluid in a rapidly expanding supercritical fluid state.

24. A machining system comprising:
a supercritical machining fluid system comprising:
a supercritical machining fluid source configured to contain a supercritical machining fluid;
at least one outlet in fluid communication with the supercritical machining fluid source;
at least one upstream sensor configured to sense one or more upstream parameters of the supercritical machining fluid upstream from the at least one outlet; and
at least one downstream sensor configured to sense one or more parameters of at least one fluid flow from the supercritical machining fluid source flowing out of the at least one outlet downstream from the at least one outlet.

25-48. (canceled)

49. A method for machining using supercritical machining fluid, the method comprising:
sensing one or more upstream parameters of a supercritical machining fluid sourced from a supercritical machining fluid source upstream of at least one outlet;
sensing one or more downstream parameters of a fluid flow from the supercritical machining fluid source downstream from the at least one outlet; and
controlling one or more machining processes based at least in part on the sensed one or more upstream parameters and the one or more downstream parameters.

50-70. (canceled)
